(19) United States
(12) Patent Application Publication
(10) Pub. No.: US 2015/0243978 A1
(43) Pub. Date: Aug. 27, 2015

(54) POSITIVE ELECTRODE ACTIVE MATERIAL, LITHIUM BATTERY CONTAINING THE SAME, AND METHOD OF MANUFACTURING THE POSITIVE ELECTRODE ACTIVE MATERIAL

(71) Applicant: Samsung Electronics Co., Ltd., Suwon-si (KR)

(72) Inventors: Jeongkuk Shon, Hwaseong-si (KR); Minsang Song, Seongnam-si (KR); Jaejun Chang, Seoul (KR); Sangmin Ji, Yongin-si (KR); Jaeman Choi, Hwaseong-si (KR); Jehwon Choi, Suwon-si (KR); Dongjin Ham, Hwaseong-si (KR)

(21) Appl. No.: 14/621,544

(22) Filed: Feb. 13, 2015

(30) Foreign Application Priority Data
Feb. 21, 2014 (KR) 10-2014-0020814

(51) Int. Cl. H01M 4/485; H01M 4/525; C01G 53/04; H01M 10/052; C01D 15/02; H01M 4/505; H01M 4/36

(52) U.S. Cl. CPC H01M 4/485; H01M 4/505; H01M 4/525; H01M 4/366; H01M 10/052; C01D 15/02; C01G 53/04; H01M 2004/021

(57) ABSTRACT

A positive electrode active material including a lithium transition metal oxide, wherein when a lithium battery including a positive electrode including the lithium transition metal oxide is analyzed by differential capacity analysis, an irreversible peak is present in a graph of differential capacity versus voltage in a range of about 4.5 volts versus lithium to about 4.8 volts versus lithium during a first charge/discharge cycle.

### CROSS-REFERENCE TO RELATED APPLICATION

This application claims priority to and the benefit of Korean Patent Application No. 10-2014-0020814, filed on Feb. 21, 2014, in the Korean Intellectual Property Office, and all the benefits accruing therefrom under 35 U.S.C. §119, the content of which is incorporated herein in its entirety by reference.

### BACKGROUND

1. Field

The present disclosure relates to a positive electrode active material, a lithium battery including the same, and a method of manufacturing the positive electrode active material.

2. Description of the Related Art

Lithium secondary batteries have recently drawn attention as a power source for small portable electronic devices. They use a non-aqueous organic electrolytic solution, and thus, have a discharge voltage that is twice or more greater than that of aqueous batteries using an aqueous alkaline electrolyte, and accordingly, have higher energy density than aqueous batteries.

Lithium secondary batteries generate electric energy due to oxidation and reduction reactions occurring when lithium ions are intercalated into/deintercalated from a positive electrode and a negative electrode, each including an active material that enables intercalation and deintercalation of lithium ions, with an organic electrolytic solution or a polymer electrolytic solution interposed between the positive electrode and the negative electrode.

As a positive electrode active material of a lithium secondary battery, LiCoO₂ has been widely used. However, LiCoO₂ is prepared at high manufacturing costs, and it is difficult to have a low cost supply thereof. Thus, as an alternative to LiCoO₂, a positive electrode active material prepared in a composite with nickel or manganese has been developed.

However, a positive electrode active material, such as a nickel-based composite oxide, under development for a low-cost, high-capacity, and a high-voltage battery, is structurally unstable and degrades upon charging and discharging the battery due to a large amount of deintercalated lithium when the battery is charged compared to when LiCoO₂ is used a positive electrode active material. Thus, as for a nickel-based composite oxide, an initial efficiency and a discharge capacity of a battery are relatively low compared to that of a battery including LiCoO₂.

Therefore, there still is a need to develop a positive electrode active material with an improved discharge capacity and a high initial efficiency.

### SUMMARY

Provided is a positive electrode active material with an improved discharge capacity and a high initial efficiency.

Provided is a positive electrode including the positive electrode active material.

Provided is a lithium battery including the positive electrode.

Provided is a method of manufacturing the positive electrode active material.

Additional aspects will be set forth in part in the description which follows and, in part, will be apparent from the description.

According to an aspect, a positive electrode active material includes a lithium transition metal oxide, wherein when a lithium battery including a positive electrode including the lithium transition metal oxide is analyzed by differential capacity analysis, an irreversible peak is present in a graph of differential capacity versus voltage in a range of about 4.5 volts versus lithium to about 4.8 volts versus lithium during a first charge/discharge cycle.

A ratio of dQ/dV of the irreversible peak to a largest reversible peak appearing in a range of about 3.6 V to about 3.9 V among oxidation peaks during the first charge/discharge cycle may be 0.3 or greater.

The irreversible peak may disappear after a second charging/discharging cycle.

The lithium transition metal oxide may be represented by Formula 1:

LiₐNi_{b}Co_{c}Mn_{d}M_{f}O₂₋ₓFₓ Formula 1

wherein M is at least one metal selected from Ti, V, Al, Mg, Cr, Fe, Zr, Re, Al, B, Ge, Ru, Sn, Nb, Mo, and Pt; 0.8≦a≦1.2, 0<b<1, 0<c<1, 0<d<1, 0≦f<1, and 0.8≦b+c+d+f≦1.2; and 0≦x<0.1.

The positive electrode active material may include secondary particles which are formed when primary particles coagulate, and the primary particles may have a rod shape.

The primary particles may have a rod shape with a length to thickness ratio of at least about 1.5.

A diameter of crystal grains in a polycrystalline structure of the primary particles may be less than about 40 nanometers (nm).

A diameter of crystal grains in a polycrystalline structure of the primary particles may be in a range of about 10 nm to about 40 nm.

The positive electrode active material may further include an amorphous carbon-based layer on a surface thereof.

According to another aspect, a positive electrode includes the positive electrode active material.

According to another aspect, a lithium battery includes a positive electrode including the positive electrode active material of claim 1; a negative electrode that is disposed facing the positive electrode; and an electrolyte that is disposed between the positive electrode and the negative electrode.

According to another aspect disclosed is a method of manufacturing a positive electrode active material, the method including providing a mixture including a transition metal precursor and a lithium precursor; and heat-treating the mixture at a temperature of 800° C. or less to prepare a lithium transition metal oxide to prepare the positive electrode active material.

The heat-treating of the mixture may be performed at a temperature in a range of about 650° C. to about 750° C.

### BRIEF DESCRIPTION OF THE DRAWINGS

These and/or other aspects will become apparent and more readily appreciated from the following description of the embodiments, taken in conjunction with the accompanying drawings in which:

FIGS. 1A to 1E show a schematic view of an embodiment of a particle structure of a positive electrode active material;

FIG. 2 is a view illustrating an embodiment of a migration pathway of lithium ions between crystal grains of the positive electrode active material;

FIG. 3 is a schematic view of a structure of an embodiment of a lithium battery;

FIGS. 4A and 4B show a scanning electron microscope (SEM) image of a N_{0.6}Co_{0.1}Mn_{0.3}(OH)₂ precursor used to manufacture the positive electrode active materials prepared in Examples 1, 3, and 5 and Comparative Examples 1 and 2;

FIGS. 5A and 5B show SEM images of a lithium transition metal oxide prepared in Example 1;

FIGS. 6A and 6B show SEM images of a lithium transition metal oxide prepared in Example 3;

FIGS. 7A and 7B show SEM images of a lithium transition metal oxide prepared in Example 5;

FIGS. 8A and 8B show SEM images of a lithium transition metal oxide prepared in Comparative Example 1;

FIGS. 9A and 9B show SEM images of a lithium transition metal oxide prepared in Comparative Example 2;

FIG. 10 is a graph of intensity (arbitrary units) versus diffraction angle (degrees two-theta, 2θ) showing the results of X-ray diffraction analysis of lithium transition metal oxides prepared in Examples 1, 3, and 5 and Comparative Examples 1 and 2 measured using a CuK radiation;

FIG. 11 is a graph of differential capacity (dQ/dV, milliampere-hours per volt, mAh/V) illustrating dQ/dV of coin half cells prepared in Examples 1, 3, and 5 and Comparative Examples 1 and 2 during a first charge/discharge cycle within a potential range of about 2.5 volts versus lithium (V) to about 4.8 V;

FIG. 12 is a graph of differential capacity (dQ/dV, milliampere-hours per volt, mAh/V) illustrating dQ/dV of the coin half cells prepared in Examples 1, 3, and 5 and Comparative Examples 1 and 2 during a second charge/discharge cycle within a potential range of about 2.5 V to about 4.8 V; and

FIG. 13 is a graph a graph of intensity (arbitrary units) versus diffraction angle (degrees two-theta, 2θ) illustrating X-ray diffraction patterns of the lithium transition metal oxides prepared in the same manner as that used in Example 3, except changing a heat-treating time to 1 hour (h), 2 h, 4 h, 6 h, 9 h, 12 h, and 18 h.

### DETAILED DESCRIPTION

Reference will now be made in detail to embodiments, examples of which are illustrated in the accompanying drawings, wherein like reference numerals refer to the like elements throughout. In this regard, the present embodiments may have different forms and should not be construed as being limited to the descriptions set forth herein. Accordingly, the embodiments are merely described herein, by referring to the figures, to explain aspects of the present description. Expressions such as “at least one of,” when preceding a list of elements, modify the entire list of elements and do not modify the individual elements of the list.

It will be understood that when an element is referred to as being “on” another element, it can be directly on the other element or intervening elements may be present therebetween. In contrast, when an element is referred to as being “directly on” another element, there are no intervening elements present.

It will be understood that, although the terms “first,” “second,” “third” etc. may be used herein to describe various elements, components, regions, layers, and/or sections, these elements, components, regions, layers, and/or sections should not be limited by these terms. These terms are only used to distinguish one element, component, region, layer or section from another element, component, region, layer, or section. Thus, “a first element,” “component,” “region,” “layer,” or “section” discussed herein could be termed a second element, component, region, layer, or section without departing from the teachings herein.

The terminology used herein is for the purpose of describing particular embodiments only and is not intended to be limiting. As used herein, the singular forms “a,” “an,” and “the” are intended to include the plural forms, including “at least one,” unless the content clearly indicates otherwise. “Or” means “and/or.” As used herein, the term “and/or” includes any and all combinations of one or more of the associated listed items. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Furthermore, relative terms, such as “lower” or “bottom” and “upper” or “top,” may be used herein to describe one element's relationship to another element as illustrated in the Figures. It will be understood that relative terms are intended to encompass different orientations of the device in addition to the orientation depicted in the Figures. For example, if the device in one of the figures is turned over, elements described as being on the “lower” side of other elements would then be oriented on “upper” sides of the other elements. The exemplary term “lower,” can therefore, encompasses both an orientation of “lower” and “upper,” depending on the particular orientation of the figure. Similarly, if the device in one of the figures is turned over, elements described as “below” or “beneath” other elements would then be oriented “above” the other elements. The exemplary terms “below” or “beneath” can, therefore, encompass both an orientation of above and below.

“About” or “approximately” as used herein is inclusive of the stated value and means within an acceptable range of deviation for the particular value as determined by one of ordinary skill in the art, considering the measurement in question and the error associated with measurement of the particular quantity (i.e., the limitations of the measurement system). For example, “about” can mean within one or more standard deviations, or within ±30%, 20%, 10%, 5% of the stated value.

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

Exemplary embodiments are described herein with reference to cross section illustrations that are schematic illustrations of idealized embodiments. As such, variations from the shapes of the illustrations as a result, for example, of manufacturing techniques and/or tolerances, are to be expected. Thus, embodiments described herein should not be construed as limited to the particular shapes of regions as illustrated herein but are to include deviations in shapes that result, for example, from manufacturing. For example, a region illustrated or described as flat may, typically, have rough and/or nonlinear features. Moreover, sharp angles that are illustrated may be rounded. Thus, the regions illustrated in the figures are schematic in nature and their shapes are not intended to illustrate the precise shape of a region and are not intended to limit the scope of the present claims.

“Transition metal” as defined herein refers to an element of Groups 3 to 11 of the Periodic Table of the Elements.

“Rare earth” means the fifteen lanthanide elements, i.e., atomic numbers 57 to 71, plus scandium and yttrium.

The “lanthanide elements” means the chemical elements with atomic numbers 57 to 71.

“Substituted” means that the compound or group is substituted with at least one (e.g., 1, 2, 3, or 4) substituent independently selected from a hydroxyl (—OH), a C1-9 alkoxy, a C1-9 haloalkoxy, an oxo (═O), a nitro (—NO₂), a cyano (—CN), an amino (—NH₂), an azido (—N₃), an amidino (—C(═NH)NH₂), a hydrazino (—NHNH₂), a hydrazono (═N—NH₂), a carbonyl (—C(═O)—), a carbamoyl group (—C(O)NH₂), a sulfonyl (—S(═O)₂—), a thiol (—SH), a thiocyano (—SCN), a tosyl (CH₃C₆H₄SO₂—), a carboxylic acid (—C(═O)OH), a carboxylic C1 to C6 alkyl ester (—C(═O)OR wherein R is a C1 to C6 alkyl group), a carboxylic acid salt (—C(═O)OM) wherein M is an organic or inorganic anion, a sulfonic acid (—SO₃H₂), a sulfonic mono- or dibasic salt (—SO₃MH or —SO₃M₂ wherein M is an organic or inorganic anion), a phosphoric acid (—PO₃H₂), a phosphoric acid mono- or dibasic salt (—PO₃MH or —PO₃M₂ wherein M is an organic or inorganic anion), a C1 to C12 alkyl, a C3 to C12 cycloalkyl, a C2 to C12 alkenyl, a C5 to C12 cycloalkenyl, a C2 to C12 alkynyl, a C6 to C12 aryl, a C7 to C13 arylalkylene, a C4 to C12 heterocycloalkyl, and a C3 to C12 heteroaryl instead of hydrogen, provided that the substituted atom's normal valence is not exceeded.

A C rate means a current which will discharge a battery in one hour, e.g., a C rate for a battery having a discharge capacity of 1.6 ampere-hours would be 1.6 amperes.

Hereinafter, according to an embodiment, a positive electrode active material, a positive electrode including the positive electrode active material, a lithium battery including the positive electrode, and a method of manufacturing the positive electrode active material will be disclosed in further detail.

In some embodiments, when a differential capacity (dQ/dV, a vertical axis) versus voltage (V, a horizontal axis) curve from differential capacity analysis of a lithium battery with a positive electrode having the lithium transition metal oxide during charge/discharge cycling is plotted, an irreversible peak is present within a range of about 4.5 volts versus lithium (V) to about 4.8 V during a first charge/discharge cycle.

In some embodiments, the lithium transition metal oxide may be an nickel-cobalt-manganese (NCM)-based oxide represented by Formula 1:

LiₐNi_{b}Co_{c}Mn_{d}M_{f}O₂₋ₓFₓ Formula 1

In Formula 1, M is at least one metal selected from Ti, V, Al, Mg, Cr, Fe, Zr, Re, Al, B, Ge, Ru, Sn, Nb, Mo, and Pt;

0.8≦a≦1.2, 0<b<1, 0<c<1, 0<d<1, 0≦f<1, 0.8≦b+c+d+f≦1.2; and 0≦x<0.1.

The lithium transition metal oxide may be represented by Formula 2:

LiₐNi_{b}Co_{c}Mn_{d}O₂ Formula 2

In Formula 2, 0.8≦a≦1.2, 0<b<1, 0<c<1, 0<d<1, and 0.8≦b+c+d≦1.2.

When the NCM-based positive electrode active material is used, an amount of cobalt used is less than when LiCoO₂ is used as a positive electrode active material, and because manganese and nickel are less expensive than cobalt, a battery including the NCM-based material has a lower cost than a battery including LiCoO₂. Also, the NCM-based positive electrode active material provides a higher discharge capacity than that of LiCoO₂.

In some embodiments, the lithium transition metal oxide may include at least about 30 mole percent (mol %) of nickel, based on the total moles of transition metals in the lithium transition metal oxide. An amount of nickel included in the lithium transition metal oxide may be, for example, at least about 60 mol %, or at least about 70 mol %, or about 30 mol % to about 90 mol %, or about 40 mol % to about 80 mol %, based on the total moles of transition metals other than lithium. In this regard, a capacity of a lithium transition metal oxide may increase by including a greater amount of nickel (Ni).

In some embodiments, in Formula 1 or 2, 0.8≦a≦1.2, 0.3≦b≦0.9, 0≦c≦0.5, 0≦d≦0.5, and 0.8≦a+b+c≦1.2; or 0.85≦a≦1.15, 0.35≦b≦0.85, 0≦c≦0.4, 0≦d≦0.4, and 0.85≦a+b+c≦1.15; or 0.9≦a≦1.1, 0.4≦b≦0.8, 0.1≦c0.3, 0.1≦d≦0.3, and 0.9≦a+b+c≦1.1.

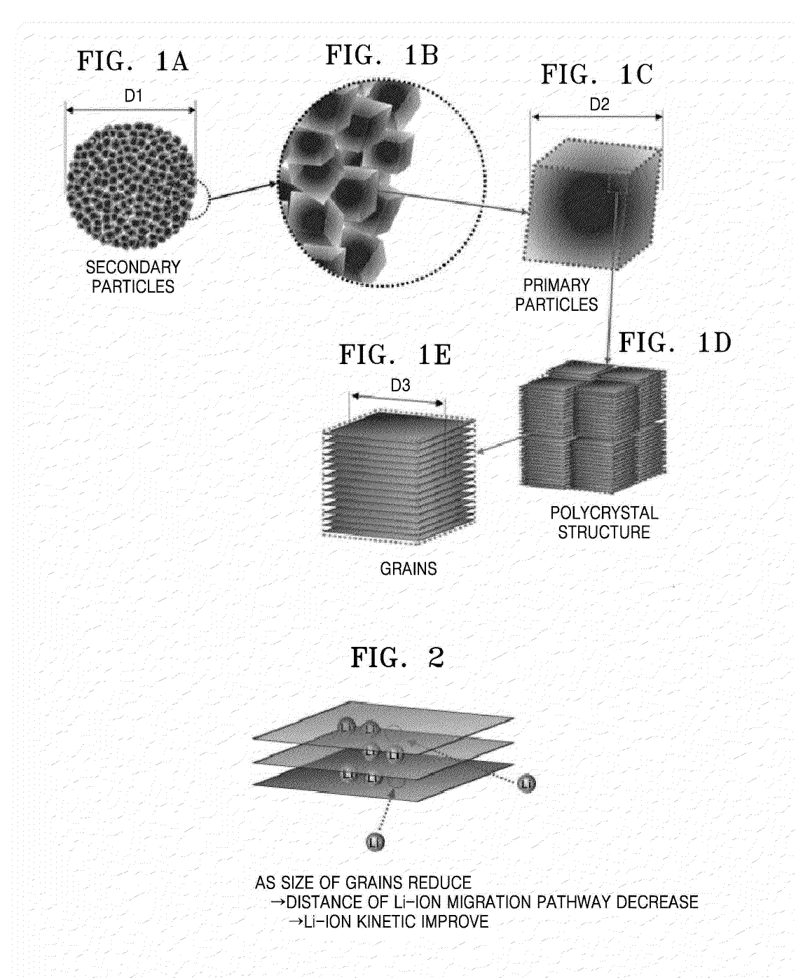

FIGS. 1A to 1E are a schematic view of a particle structure of an embodiment of the positive electrode active material.

As shown in FIGS. 1A to 1E, the positive electrode active material comprises secondary particles, wherein the secondary particles comprise an agglomeration of primary particles as can be provided by coagulation, for example, and wherein the primary particles have a polycrystalline structure comprising crystal grains of the lithium transition metal oxide.

The primary particles may have a rod shape. The positive electrode active material may be prepared using a heat-treating process at a relatively low temperature compared to a currently used heat-treating synthesis method. Surprisingly, when the lower temperature heat-treating method is used, the primary particles may have a rod shape, instead of a spherical shape. For example, the primary particles may have a rod shape with a length to thickness ratio of at least about 1.5, or about 1.5 to about 1000, or about 3 to about 700, or about 5 to about 500. For example, the primary particles may have a rod shape with a length to thickness ratio of at least about 2. The primary particles having a rod shape may increase a mixture density of a positive electrode plate and thus may be advantageous for high rate charging/discharging performance.

In some embodiments, an average particle diameter D₁ of the secondary particles of the positive electrode active material may be in a range of about 1 micrometer (μm) to about 100 μm, about 2 μm to about 80 μm, or about 4 μm to about 60 μm. For example, an average particle diameter D₁ of the secondary particles of the positive electrode active material may be in a range of about 10 μm to about 50 μm. A lithium battery having improved physical properties may be provided when an average particle diameter of the secondary particles of the positive electrode active material is within these ranges above.

The average particle diameter may be a D50, which refers to a particle diameter corresponding to 50% from the smallest particle, when the total number of particles is 100%, in a distribution curve showing particles accumulated from the smallest particle to the largest particle. The particle size, e.g., D50, may be measured using a standard method, the details of which can be determined by one of skill in the art without undue experimentation, for example, by using a particle diameter analyzer or by measuring a particle diameter from a transmission electron microscopy (TEM) image or a scanning electron microscope (SEM) image. Alternatively, for example, an average particle diameter may be easily obtained by calculation after measuring a particle diameter by dynamic light-scattering and counting the number of particles with respect to each diameter range by performing data analysis.

A diameter of the crystal grains of the positive electrode active material may be selected by controlling the heat-treatment conditions. The positive electrode active material may be prepared by heat-treating at a relatively low temperature compared to that of a heat-treating in a current synthesis method. A current heat-treating temperature is at least 900° C., but the positive electrode active material may be heat-treated at a lower temperature of about 800° C. or lower to obtain a lithium transition metal oxide. The lower the heat-treating temperature, the smaller the diameter of the crystal grains. A diameter of the crystal grains D₃ of the positive electrode active material may be several tens of nanometers. The smaller the diameter of the crystal grains, the smaller the diameter of the primary particles.

As shown in FIG. 2, the positive electrode active material with crystal grains having a reduced diameter may shorten a length of a migration pathway for intercalating and deintercalating lithium ions during charge/discharge cycling, and thus a capacity, a high rate charging/discharging performance, and an initial efficiency may be improved by increasing kinetics of the lithium ions.

In some embodiments, a diameter of crystal grains D₃ in a polycrystalline structure forming the primary particles may be less than about 40 nanometers (nm). For example, a diameter of the crystal grains D₃ may be at least about 10 nm and less than 40 nm. For example, a diameter of the crystal grains D₃ may be about 16 nm to about 37 nm. For example, a diameter of the crystal grains D₃ may be about 20 nm to about 30 nm.

A diameter of the crystal grains D₃ may be calculated by using a full-width half-maximum of a sample peak that appears in an X-ray diffraction (XRD) analysis using, e.g., CuKα radiation. A diameter of the crystal grains D₃ may be determined to be a little different depending on which peak in an XRD graph is selected for analysis. For example, a diameter of the crystal grains may be calculated using an [003] peak that appears within a range of a diffraction angle between about 17° and about 20° 2θ.

In some embodiments, a full-width half-maximum of the [003] peak that appears within a range of a diffraction angle between about 17° and about 20° 2θ in the XRD graph may be about 0.2° to about 0.5°, about 0.25° to about 0.45°, or about 0.3° to about 0.4°. When the full-width half-maximum is within this range, a desired diameter of the crystal grains may be obtained.

In the positive electrode active material, to provide a smaller diameter of the crystal grains, a diameter of the primary particles may be small. In some embodiments, a diameter of the primary particles D₂ may be in a range of about 100 nm to about 500 nm, about 150 nm to about 450 nm, or about 200 nm to about 400 nm. In some embodiments, a length of the primary particles may be in a range of about 100 nm to about 500 nm, about 150 nm to about 450 nm, or about 200 nm to about 400 nm.

The lithium transition metal oxide obtained using the low-temperature heat-treating process shows an identifying characteristic by differential capacity or cyclic voltammetry analysis. In particular, in differential capacity analysis, in a graph of differential capacity (dQ/dV, a vertical axis) versus voltage versus lithium (V, a horizontal axis) of a lithium battery with a positive electrode having the lithium transition metal oxide during charge/discharge cycling, an irreversible peak is present within a range of about 4.5 V to about 4.8 V, about 4.52 V to about 4.78 V, or about 4.54 V to about 4.76 V, during a first charging/discharging cycle.

It is not clear whether the irreversible peak shown within the particular voltage range is generated by the reduced diameter of the crystal grains or by a particular phase which is difficult to detect, but it is presumed that the irreversible peak is generated by the change of a crystalline structure caused by the low-temperature heat-treatment. The irreversible peak is not observed from the lithium transition metal oxide obtained by a high-temperature heat-treatment synthesis method at a temperature of about 900° C. or higher.

During the first charging/discharging cycle, a ratio of a dQ/dV value of the irreversible peak with respect to a largest reversible peak in the range of 3.6 V to 3.9 V versus lithium among oxidation peaks may be about 0.3 or higher, or about 0.3 to about 0.98, about 0.35 to about 0.95, about 0.4 to about 0.92, or about 0.5 to about 0.9.

A dQ/dV value of the irreversible peak on a second charging/discharging cycle is half or less of a dQ/dV value of the irreversible peak during the first charging/discharging cycle. That is, the irreversible peak starts to disappear when a ratio of the dQ/dV value of the irreversible peak during the second charging/discharging cycle to the dQ/dV value of the irreversible peak during the first charging/discharging cycle is reduced to 0.5 or less. Most of the irreversible peaks may disappear after the second charging/discharging cycle. When a lithium transition metal oxide obtained by a high-temperature synthesis method that includes heat-treatment at a temperature of about 900° C. or higher is used, the irreversible peak with such characteristics may not be observed.

In some embodiments, a specific surface area obtained by a Brunauer Emmett and Teller (BET) method of the positive electrode active material may be about 2 square meters per gram (m²/g) or greater. The specific surface area of the positive electrode active material may be, for example, about 3 m²/g or greater, about 4 m²/g or greater, or about 5 m²/g or greater, about 2 m²/g to about 100 m²/g, about 4 m²/g to about 90 m²/g, or about 6 m²/g to about 80 m²/g. When a specific surface area of the positive electrode active material is within these ranges, an initial charging/discharging efficiency may increase according to a reduced reactivity with an electrolyte.

In some embodiments, the positive electrode active material may further include an amorphous carbon-based coating layer, e.g., a layer or coating, on a surface thereof. Here, the term “amorphous” denotes that a material does not have a particular crystalline structure. The amorphous carbon-based coating layer may include, for example, at least about 50 weight percent (wt %), about 60 wt %, about 70 wt %, about 80 wt %, or about 90 wt %, or about 50 wt % to about 100 wt %, about 55 wt % to about 95 wt %, or about 60 wt % to about 90 wt % of amorphous carbon, based on a total weight of the amorphous carbon-based coating layer, or the amorphous carbon-based coating layer may be formed of about 100 wt % of amorphous carbon.

The amorphous carbon-based coating layer may include at least one material selected from soft carbon (soft carbon: a lower temperature fired carbon), hard carbon (hard carbon: a higher temperature fired carbon), pitch carbide, mesophase pitch carbide, and a fired coke. Soft carbon may be a product of heat-treating a residue of petroleum pitch or coal, and hard carbon may be a product of heat-treating at least one selected from a polyimide resin, furan resin, phenol resin, polyvinyl alcohol resin, cellulose resin, epoxy resin, and polystyrene resin.

A method of disposing the amorphous carbon-based coating layer may be, but is not limited to, a dry coating method or a liquid-phase coating method. Examples of a dry coating method may include vapor deposition, chemical vapor deposition (CVD), and the like. Examples of a liquid-phase coating method may include, for example, impregnation, a spray method, and the like. For example, an amorphous carbon-based coating layer may be formed by coating and heat-treating the secondary particles including a lithium transition metal oxide with a carbon precursor, such as, at least one selected from coal-based pitch, mesophase pitch, petroleum-based pitch, coal-based oil, petroleum-based heavy oil, organic synthetic pitch, and a polymer resin, such as, at least one selected from a phenol resin, a furan resin, and a polyimide resin.

The amorphous carbon-based coating layer may be formed at an appropriate thickness within a range for providing a sufficient conduction pathway between the second particles and not reducing a battery capacity. For example, a thickness of the amorphous carbon-based coating layer may be, but is not limited to, from about 0.01 μm to about 10 μm, for example, from about 0.1 μm to about 5 μm, or from about 0.1 μm to about 3 μm.

In some embodiments, the coating layer may be a uniform continuous coating layer.

In some embodiments, the coating layer may be a discontinuous coating layer of an island-type. Here, the term “island-type” denotes that the coating layer has a non-predetermined shape, such as a sphere, a semi-sphere, or a non-sphere, with a volume, but the shape is not particularly limited thereto. The coating layer of an island-type may include particles that are discontinuously coated on the layer or may have an irregular form having a predetermined volume by coagulating a plurality of particles.

According to another embodiment, a method of manufacturing the positive electrode active material includes providing, e.g., preparing, a mixture including a transition metal precursor and a lithium precursor as starting materials for forming a lithium transition metal oxide; and heat-treating the mixture at a temperature of about 800° C. or less to prepare a lithium transition metal oxide to prepare the positive electrode active material.

In some embodiments, the transition metal precursor may include a compound of the formula Ni_{b}Co_{c}Mn_{d}(OH)_{y}, wherein 0.8≦b+c+d≦1.2; 0<b<1, 0<c<1, 0<d<1; and 1.8≦y≦2.2, wherein 0.85≦b+c+d≦1.15; 0.1<b<0.95, 0.1<c<0.95, 0.1<d<0.95; and 1.85≦y≦2.15, or wherein 0.9 b+c+d≦1.1; 0.15<b<0.9, 0.1<c<0.9, 0.1<d<0.9; and 1.8≦y≦2.1.

The transition metal precursor may include at least one metal cation (M) selected from Ti, V, Al, Mg, Cr, Fe, Zr, Re, Al, B, Ge, Ru, Sn, Nb, Mo, and Pt. The metal cation may be supplied as a hydroxide or an oxide in the preparation of the transition metal precursor and thus is understood to be homogeneously mixed in the transition metal precursor. The transition metal precursor including a metal cation may be represented by the formula Ni_{b}Co_{c}Mn_{d}M_{f}(OH)_{y}, wherein 0.8≦b+c+d+f≦1.2; 0<b<1, 0<c<1, 0<d<1, 0≦f<1; and 1.8≦y≦2.2, 0.8≦b+c+d+f≦1.2; 0<b<1, 0<c<1, 0<d<1, 0 ≦f<1; and 1.8≦y≦2.2, or 0.8≦b+c+d+f≦1.2; 0<b<1, 0<c<1, 0<d<1, 0≦f<1; and 1.8≦y≦2.2.

The lithium precursor may include at least one of LiOH, Li₂Co₃, LiNH₂, LiCl, and LiBr.

In some embodiments, an initial efficiency may improve by further adding a fluorine compound as another starting material.

The fluorine compound may include at least one of lithium fluoride (e.g., LiF), magnesium fluoride (e.g., MgF₂), strontium fluoride (e.g., SrF₂), beryllium fluoride (e.g., BeF₂), calcium fluoride (e.g., CaF₂), ammonium fluoride (e.g., NH₄F), ammonium bifluoride (e.g., NH₄HF₂), and ammonium hexafluoroaluminate (e.g., (NH₄)₃AlF₆).

An amount of each of the starting materials may be stoichiometric depending on a composition of the positive electrode active material.

A mixture of the starting material may be used to prepare the positive electrode active material through a solid-state reaction.

In some embodiments, the heat-treating may be performed in air at a temperature of about 800° C. or lower. A temperature of the heat-treating may be, for example, from about 600° C. to about 800° C. or from about 650° C. to about 750° C. A heat-treating time may be about 2 hours to about 20 hours, 3 hours to about 18 hours, or about 4 hours to about 16 hours.

According to another embodiment, a positive electrode may include the positive electrode active material described above.

For example, the positive electrode may be manufactured in the following manner. First, a positive electrode slurry composition may be prepared by mixing the positive electrode active material, a conducting agent, a binder, and a solvent. The positive electrode slurry composition may be directly coated and dried on a positive electrode current collector to prepare a positive electrode plate having a positive electrode active material layer thereon. Alternatively, the positive electrode slurry composition may be cast on a separate support, and then a film obtained from the support may be laminated on a positive electrode current collector to prepare a positive electrode plate having a positive electrode active material layer thereon.

The conducting agent may comprise at least one selected from carbon, a metal, and conductive organic compound. Examples of the conducting agent may include at least one selected from carbon black, graphite microparticles, natural graphite, artificial graphite, acetylene black, Ketjen black, carbon fibers; carbon nanotubes; a metal powder, metal fibers, or metal tubes of copper, nickel, aluminum, or silver; and a conductive polymer such as a polyphenylene derivatives, but the conducting agent is not limited thereto, and any suitable material available in the art may be used.

Examples of the binder include a vinylidene fluoride/hexafluoropropylene copolymer, polyvinylidene fluoride (PVDF), polyacrylonitrile, polymethylmethacrylate, polytetrafluoroethylene (PTFE), mixtures thereof, and a styrene butadiene rubber-based polymer, but the binder is not limited thereto, and any suitable material available in the art may be used. Examples of the solvent may include at least one selected from N-methyl-pyrrolidone (NMP), acetone, and water, but the solvent is not limited thereto, and any suitable material available in the art may be used.

In an implementation, a plasticizer may be further added to the positive electrode slurry composition to form pores in the electrode plate.

Amounts of the positive electrode active material, the conducting agent, the binder, and the solvent may correspond with those used in the manufacture of a lithium battery. At least one of the conducting agent, the binder, and the solvent may be omitted, according to a use and a structure of the lithium battery.

Also, the positive electrode may include the positive electrode active material alone or may further include an additional positive electrode active material having suitable technical characteristics, which include a composition and a particle diameter, different from that of the positive electrode active material.

Any suitable material that may be used as a positive electrode active material in the art may be used. For example, a positive electrode active material with a composition different from Formula 1 or 2 may be a compound represented by one of formulas LiₐA_{1-b}B′_{b}D′₂ (where, 0.90≦a≦1 and 0≦b≦0.5); LiₐE_{1-b}B′_{b}O_{2-c}D′_{c} (where, 0.90≦a≦1, 0≦b≦0.5, and 0≦c≦0.05); LiE_{2-b}B′_{b}O_{4-c}D′_{c} (where, 0≦b≦0.5 and 0≦c≦0.05); LiₐNi_{1-b-c}Co_{b}B′_{c}D′_{α} (where, 0.90≦a≦1, 0≦b≦0.5, 0≦c≦0.05, and 0<α<2); LiₐNi_{1-b-c}Co_{b}B′_{c}O_{2-α}F′_{α} (where, 0.90≦a≦1, 0≦b≦0.5, 0≦c≦0.05, and 0<α<2); LiₐNi_{1-b-c}Co_{b}B′_{c}O_{2-α}F′₂ (where, 0.90≦a≦1, 0≦b≦0.5, 0≦c≦0.05, and 0<α<2); LiₐNi_{1-b-c}Mn_{b}B′_{c}D′_{α} (where, 0.90≦a≦1, 0≦b≦0.5, 0≦c≦0.05, and 0<α 2); LiₐNi_{1-b-c}Mn_{b}B′_{c}O_{2-α}F′_{α} (where, 0.90≦a≦1, 0≦b≦0.5, 0≦c≦0.05, and 0<α<2); LiₐNi_{1-b-c}Mn_{b}B′_{c}O_{2-α}F′₂ (where, 0.90≦a≦1, 0≦b≦0.5, 0≦c≦0.05, and 0<α<2); LiₐNi_{b}E_{c}G_{d}O₂ (where, 0.90≦a≦1, 0≦b≦0.9, 0≦c≦0.5, and 0.001≦d≦0.1); LiₐNi_{b}Co_{c}Mn_{d}GeO₂ (where, 0.90≦a≦1, 0≦b≦0.9, 0≦c≦0.5, 0≦d≦0.5, and 0.001≦e≦0.1); LiₐNiG_{b}O₂ (where, 0.90≦a≦1 and 0.001≦b≦0.1); LiₐCoG_{b}O₂ (where, 0.90≦a≦1 and 0.001≦b≦0.1); LiₐMnG_{b}O₂ (where, 0.90≦a≦1 and 0.001≦b≦0.1); LiₐMn₂G_{b}O₄ (where, 0.90≦a≦1 and 0.001≦b≦0.1); QO₂; QS₂; LiQS₂; V₂O₅; LiV₂O₅; LiI′O₂; LiNiVO₄; Li_{(3-f)}J₂(PO₄)₃ (where, 0≦f≦2); Li_{(3-f)}Fe₂(PO₄)₃ (where, 0≦f≦2); and LiFePO₄.

In the formulas above, A is Ni, Co, Mn, or a combination thereof; B′ is Al, Ni, Co, Mn, Cr, Fe, Mg, Sr, V, a rare earth element, or a combination thereof; D′ is O, F, S, P, or a combination thereof; G is Al, Cr, Mn, Fe, Mg, La, Ce, Sr, V, or a combination thereof; Q is Ti, Mo, Mn, or a combination thereof; I′ is Cr, V, Fe, Sc, Y, or a combination thereof; and J is V, Cr, Mn, Co, Ni, Cu, or a combination thereof.

For example, a positive electrode active material may be LiCoO₂, LiMnₓO₂ₓ(x=1, 2), LiNi₁₋ₓMnₓO₂ₓ(0<x<1), or FePO₄.

The compounds listed above as a positive electrode active material may have a surface coating layer (hereinafter, a “coating layer”). The coating layer may include at least one compound of a coating element selected from the group selected from an oxide, hydroxide, oxyhydroxide, oxycarbonate, and hydroxycarbonate of the coating element. The compounds for the coating layer may be amorphous or crystalline. The coating element for the coating layer may include at least one selected from Mg, Al, Co, K, Na, Ca, Si, Ti, V, Sn, Ge, Ga, B, As, and Zr. The coating layer may be formed using any suitable method that does not adversely affect the physical properties of the positive electrode active material when a compound of the coating element is used. For example, the coating layer may be formed using a spray coating method, a dipping method, or the like.

A thickness of the positive electrode current collector may be from about 3 μm to about 500 μm, about 6 μm to about 400 μm, or about 9 μm to about 300 μm. A material for the positive electrode current collector is not particularly limited as long as the material is conductive and does not generate an undesirable chemical change in a battery. Examples of the positive electrode current collector include at least one selected from copper, stainless steel, aluminum, nickel, titanium, sintered carbon, aluminum, and stainless steel that is surface-treated with at least one selected from carbon, nickel, titanium, silver, and an aluminum-cadmium alloy. An adhesive strength of the positive electrode active material may enhance by having fine irregularities on a surface of the positive electrode current collector, and the positive electrode current collector may be used in any of various forms including films, sheets, foils, nets, porous structures, foams, and non-woven fabrics.

A mixture density of the positive electrode may be at least about 2.0 grams per cubic centimeter (g/cc).

A lithium battery according to another embodiment may include a positive electrode including the positive electrode active material. For example, the lithium battery may include a positive electrode including the positive electrode active material; a negative electrode disposed facing the positive electrode; and an electrolyte disposed between the positive electrode and the negative electrode.

The positive electrode in the lithium battery may be manufactured in the same manner used in the manufacture of the positive electrode described above.

The negative electrode may be prepared as follows. The negative electrode may be prepared in the same manner as used in the preparation of the positive electrode, except that a negative electrode active material is used instead of the positive electrode active material. Also, the same conducting agent, binder, and solvent used in the preparation of the positive electrode may be used to prepare a negative electrode slurry composition.

For example, the negative electrode may be manufactured in the following manner. First, a negative electrode slurry composition may be prepared by mixing the negative electrode active material, a binder, a solvent, and optionally a conducting agent. The negative electrode slurry composition may be directly coated and dried on a negative electrode current collector to prepare a negative electrode plate having a negative electrode active material layer thereon. Alternatively, the negative electrode slurry composition may be cast on a separate support, and then a film obtained from the support may be laminated on a negative electrode current collector to prepare a negative electrode plate having a negative electrode active material layer thereon.

Also, any suitable negative electrode active material available in the art as a negative electrode active material of a lithium battery may be used. Examples of the negative electrode active material include at least one selected from lithium metal, a metal that is alloyable with lithium, a transition metal oxide, a non-transition metal oxide, and a carbonaceous material.

Examples of the metal alloyable with lithium may include at least one selected from Si, Sn, Al, Ge, Pb, Bi, Sb a Si—Y′ alloy (where Y′ is an alkali metal, an alkaline earth metal, a Group 13 element, a Group 14 element, a transition metal, a rare earth element, or a combination thereof except for Si), and a Sn—Y′ alloy (where Y is an alkali metal, an alkaline earth metal, a Group 13 element, a Group 14 element, a transition metal, a rare earth element, or a combination thereof except for Sn). Y′ may be at least one selected from magnesium (Mg), calcium (Ca), strontium (Sr), barium (Ba), radium (Ra), scandium (Sc), yttrium (Y), titanium (Ti), zirconium (Zr), hafnium (Hf), rutherfordium (Rf), vanadium (V), niobium (Nb), tantalum (Ta), dubnium (Db), chromium (Cr), molybdenum (Mo), tungsten (W), seaborgium (Sg), technetium (Tc), rhenium (Re), bohrium (Bh), iron (Fe), lead (Pb), ruthenium (Ru), osmium (Os), hassium (Hs), rhodium (Rh), iridium (Ir), palladium (Pd), platinum (Pt), copper (Cu), silver (Ag), gold (Au), zinc (Zn), cadmium (Cd), boron (B), aluminum (Al), gallium (Ga), tin (Sn), indium (In), titanium (Ti), germanium (Ge), phosphorus (P), arsenic (As), antimony (Sb), bismuth (Bi), sulfur (S), selenium (Se), tellurium (Te), and polonium (Po).

Examples of the transition metal oxide may include a lithium titanium oxide, a vanadium oxide, and a lithium vanadium oxide.

Examples of the non-transition metal oxide may include SnO₂ and SiOₓ (where, 0<x<2).

Examples of the carbonaceous material may include crystalline carbon, amorphous carbon, and a mixture thereof. Examples of the crystalline carbon may include graphite, such as natural graphite or artificial graphite that are in amorphous, plate, flake, spherical, or fibrous form. Examples of the amorphous carbon may include soft carbon (carbon sintered at low temperatures), hard carbon, mesophase pitch carbides, and sintered cokes.

Amounts of the negative electrode active material, the conducting agent, the binder, and the solvent may correspond to levels that are generally used in the manufacture of a lithium battery.

A thickness of the negative electrode current collector may be generally from about 3 μm to about 500 μm, about 6 μm to about 450 μm, or about 9 μm to about 400 μm. A material for the negative electrode current collector is not particularly limited as long as the material is conductive and does not generate chemical change of a battery. Examples of the positive electrode current collector include at least one selected from copper, stainless steel, aluminum, nickel, titanium, sintered carbon, aluminum, and stainless steel that is surface-treated with at least one selected from carbon, nickel, titanium, or silver, and aluminum-cadmium alloy. An adhesive strength of the negative electrode active material may enhance by having fine irregularities on a surface of the negative electrode current collector, and the negative electrode current collector may be used in any of various forms including films, sheets, foils, nets, porous structures, foams, and non-woven fabrics.

The positive electrode and the negative electrode may be separated by a separator, and any separator generally used in the art may be used. Particularly, the separator may have low resistance to migration of ions in an electrolyte and may have an excellent electrolyte-retaining ability. Examples of materials for forming the separator may include at least one selected from glass fibers, polyester, Teflon, polyethylene, polypropylene, and polytetrafluoroethylene (PTFE), each of which may be a non-woven or woven fabric. The separator may have a pore diameter from about 0.01 μm to about 10 μm, about 0.05 μm to about 5 μm, or about 0.1 μm to about 1 μm and a thickness from about 5 μm to about 300 μm, about 10 μm to about 250 μm, or about 15 μm to about 200 μm.

A lithium salt-containing non-aqueous electrolyte comprises a non-aqueous electrolyte and lithium. Examples of the non-aqueous electrolyte include a non-aqueous electrolyte solution, an organic solid electrolyte, and an inorganic solid electrolyte.

Examples of the non-aqueous electrolyte solution may include at least one selected from N-methyl-2-pyrrolidone, propylene carbonate, ethylene carbonate, butylene carbonate, dimethyl carbonate, diethyl carbonate, γ-butyrolactone, 1,2-dimethoxyethane, tetrahydrofuran, 2-methyl tetrahydrofuran, dimethylsulfoxide, 1,3-dioxane, formamide, dimethylformamide, dioxolane, acetonitrile, nitromethane, methyl formate, methyl acetate, phosphate trimester, trimethoxy methane, a substituted dioxolane, sulfolane, methylsulfolane, 1,3-dimethyl-2-imidazolidinone, a substituted propylene carbonate, a substituted tetrahydrofuran, ether, methyl propionate, and ethyl propanoate.

Examples of the organic solid electrolyte may include at least one selected from a substituted polyethylene, a substituted polyethylene oxide, a substituted polypropylene oxide, a phosphate ester polymer, a polyagitation lysine, a polyester sulfide, a polyvinyl alcohol, a polyvinylidene fluoride, and a polymer including an ionic dissociation group.

Examples of the inorganic solid electrolyte include nitrides, halides, and sulfates of lithium (Li), such as Li₃N, Lil, Li₅NI₂, Li₃N—LiI—LiOH, LiSiO₄, LiSiO₄—LiI—LiOH, Li₂SiS₃, Li₄SiO₄, Li₄SiO₄—LiI—LiOH, and Li₃PO₄—Li₂S—SiS₂.

The lithium salt is a material suitable for being dissolved in the non-aqueous electrolyte, and for example, LiCl, LiBr, Lil, LiClO₄, LiBF₄, LiB₁₀Cl₁₀, LiPF₆, LiCF₃SO₃, LiCF₃CO₂, LiAsF₆, LiSbF₆, LiAlCl₄, CH₃SO₃Li, CF₃SO₃Li, (CF₃SO₂)₂NLi, choloroborane lithium, a lower aliphatic (C1-C8) lithium carboxylic acid, lithium tetraphenyl borate, and imide may be used.

A lithium battery may be a lithium ion battery, a lithium ion polymer battery, or a lithium polymer battery depending on a separator and an electrolyte used in the lithium battery. The lithium secondary battery may be a cylindrical type, a rectangular type, a coin type, or a pouch type depending on a shape of the battery and may be a bulk type or a thin-film type depending on a diameter of the battery. Also, the lithium battery may be a lithium primary battery or a lithium secondary battery.

Methods for manufacturing a lithium battery of the types stated above can be determined by one of skill in the art without undue instrumentation, and thus detailed description of the methods is omitted here for clarity.

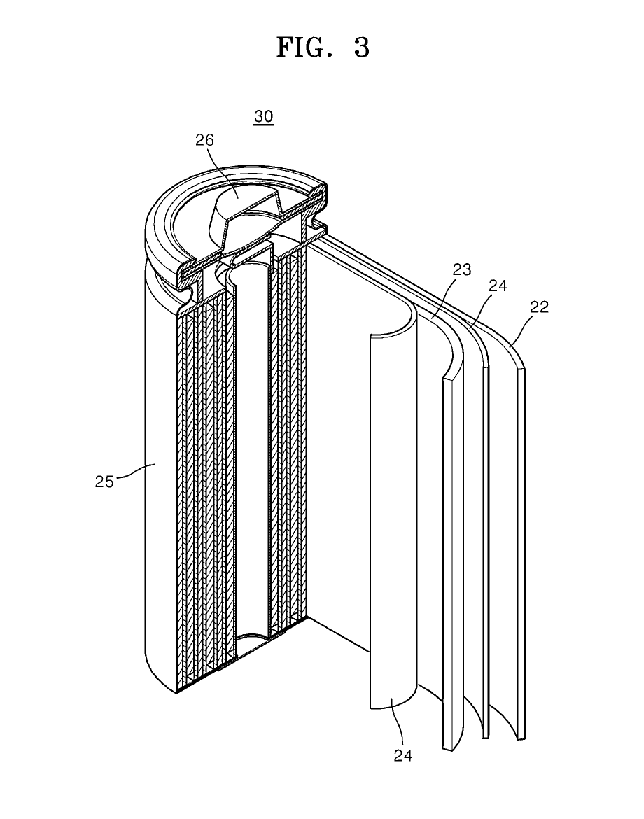

FIG. 3 is a schematic view of a representative structure of an embodiment of a lithium battery 30.

Referring to FIG. 3, the lithium battery 30 includes a positive electrode 23, a negative electrode 22, and a separator 24 disposed between the positive electrode 23 and the negative electrode 22. The positive electrode 23, the negative electrode 22, and the separator 24 may be wound or folded and then accommodated in a battery case 25. Then, the battery case 25 may be filled with an organic electrolyte solution and sealed with a cap assembly 26, thereby completing manufacture of the lithium battery 30. The battery case 25 may be a cylindrical type, a rectangular type, or a thin-film type. The lithium battery may be a lithium ion battery.

The lithium battery may be appropriate for being used in an electric vehicle (EV), which requires a battery with a high capacity, high output, and good performance at a high temperature, as well as in a cell phone or a portable computer. Also, the lithium battery may be combined with an internal system, a fuel battery, and a supercapacitor and thus may be used in a hybrid vehicle. In addition, the lithium battery may be used in an electric bicycle, a power tool, or the like that requires battery with a high capacity, high output, and good performance at a high temperature.

An embodiment will now be described in more detail with reference to the following examples. However, these examples are for illustrative purposes only and are not intended to limit the scope of the disclosed embodiments.

### Example 1

### (1) Preparation of Positive Electrode Active Material

2 molar (M) nickel sulfate aqueous solution (NiSO₄.7(H₂O), available from Aldrich), 2 M cobalt sulfate aqueous solution (CoSO₄.7(H₂O), available from Aldrich), and 2 M manganese sulfate aqueous solution (MnSO₄.x(H₂O), available from Aldrich) were each prepared. Then, a mixture was prepared by mixing the nickel sulfate aqueous solution, the cobalt sulfate aqueous solution, and the manganese sulfate aqueous solution such that a molar ratio between nickel, cobalt, and manganese included in the mixture was 6:1:3. The mixture was contacted with 2 M Na₂CO₃ aqueous solution at a rate of 3 millimeters per minute (mL/min) in 4 L of 0.2 M Na₄OH aqueous solution while maintaining pH 11 for 10 hours, and the precipitate obtained therefrom was filtered. The precipitate was washed with water, dried, mixed with LiOH (Aldrich) to have a molar ratio of Li:Ni:Co:Mn=1.0:0.6:0.1:0.3, and then heat-treated at a temperature of 600° C. for 6 hours in the air to obtain a lithium transition metal oxide (LiNi_{0.6}Co_{0.1}Mn_{0.3}O₂) powder.

### (2) Preparation of Coin Half Cell

The lithium metal oxide and carbon black (Super-P; Timcal Ltd.) were mixed at a weight ratio of 90:6, and 5 wt % of a pyrrolidone solution including a polyvinylidene fluoride (PVDF) binder (SOLEF 5130) was added, so that a weight ratio of a positive electrode active material:a carbon conducting agent:a binder to be 90:6:4, and thus a positive electrode active material slurry was prepared.

An aluminum foil having a thickness of 15 μm was coated with the active material slurry at a thickness of about 40 μm to about 50 μm using a doctor blade, dried, and additionally dried again at a temperature of 120° C. in vacuum to prepare a positive electrode plate. The positive electrode plate was pressed using a roll press to prepare a positive electrode for a coin cell of a sheet-type.

A coin-type half cell (CR2032 type) having a diameter of 12 mm was prepared by using the positive electrode.

In the manufacture of the cell, lithium was used to prepare a counter electrode, a propylene separator (Celgard 3501) was used as a separator, 1.1 M LiPF₆ and 0.2 M LiBF₄ dissolved in a mixture of ethylene carbonate (EC):diethyl carbonate (DEC):fluoroethylene carbonate (FEC) at a volume ratio of 2:6:2.

### Example 2

A positive electrode active material and a coin half cell were prepared in the same manner used in Example 1, except that a heat-treating temperature in the preparation of the lithium transition metal oxide was changed to 650° C.

### Example 3

A positive electrode active material and a coin half cell were prepared in the same manner used in Example 1, except that a heat-treating temperature in the preparation of the lithium transition metal oxide was changed to 700° C.

### Example 4

A positive electrode active material and a coin half cell were prepared in the same manner used in Example 1, except that a heat-treating temperature in the preparation of the lithium transition metal oxide was changed to 750° C.

### Example 5

A positive electrode active material and a coin half cell were prepared in the same manner used in Example 1, except that a heat-treating temperature in the preparation of the lithium transition metal oxide was changed to 800° C.

### Comparative Example 1

A positive electrode active material and a coin half cell were prepared in the same manner used in Example 1, except that a heat-treating temperature in the preparation of the lithium transition metal oxide was changed to 900° C.

### Comparative Example 2

A positive electrode active material and a coin half cell were prepared in the same manner used in Example 1, except that a heat-treating temperature in the preparation of the lithium transition metal oxide was changed to 1000° C.

### Evaluation Example 1

### SEM Analysis

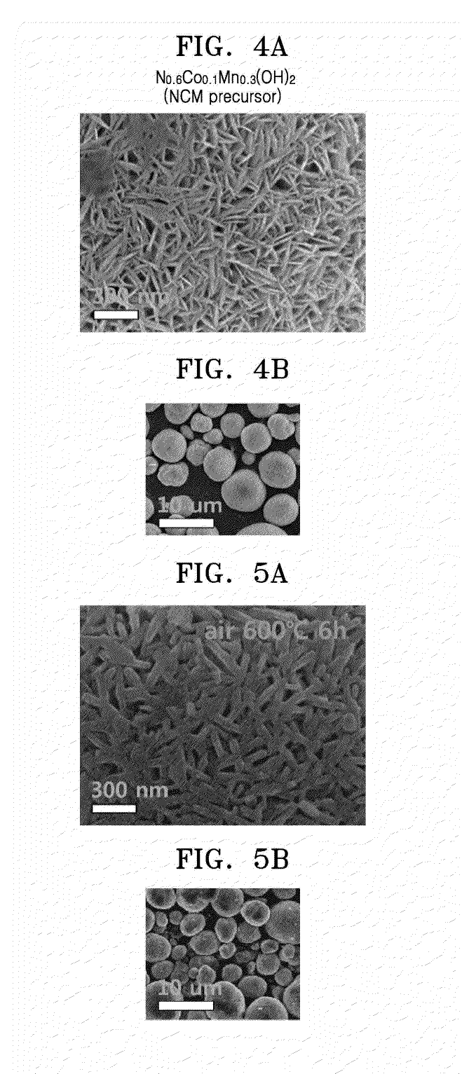

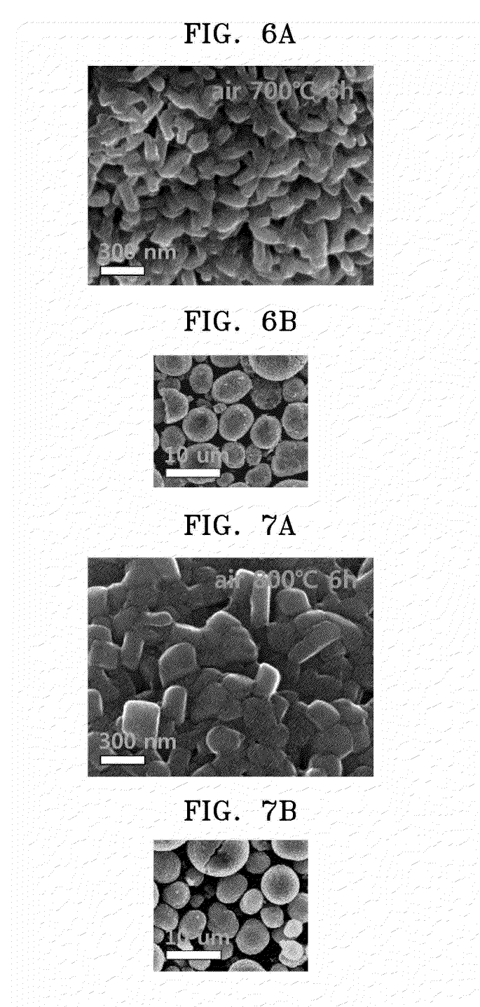

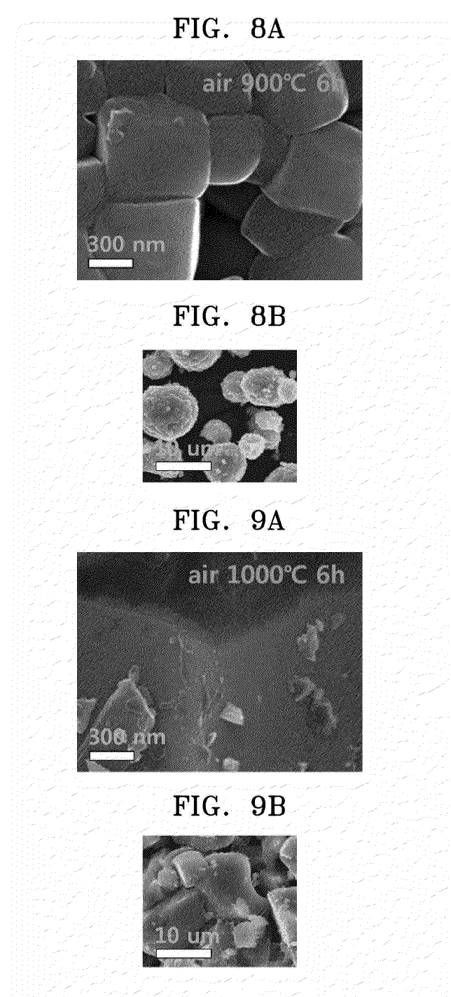

SEM images of the N_{0.6}Co_{0.1}Mn_{0.3}(OH)₂ precursor used in the preparation of the positive electrode active materials prepared in Examples 1, 3, and 5 and Comparative Examples 1 and 2 are shown in FIGS. 4A and 4B, and SEM images of the lithium transition metal oxides prepared in Examples 1, 3, and 5 and Comparative Examples 1 and 2 are, each respectively, shown in FIGS. 5A to 9B. In each of FIGS. 4A to 9B, the “A” image is an image of primary particles and the “B” image is an image of secondary particles.

As shown in FIGS. 4A to 9B, it may be confirmed that a diameter of the primary particles reduce as a heat-treating temperature is low. Also, the primary particles are formed in a rod shape at a heat-treating temperature of 800° C. or less. However, a diameter of the primary particles increased at a heat-treating temperature of 900° C., and thus the primary particles are coagulated with each other and form a cube shape. At heat-treating temperature of 1000° C., the primary particles are coagulated with each other and form a large one-body particle.

### Evaluation Example 2

### XRD Evaluation

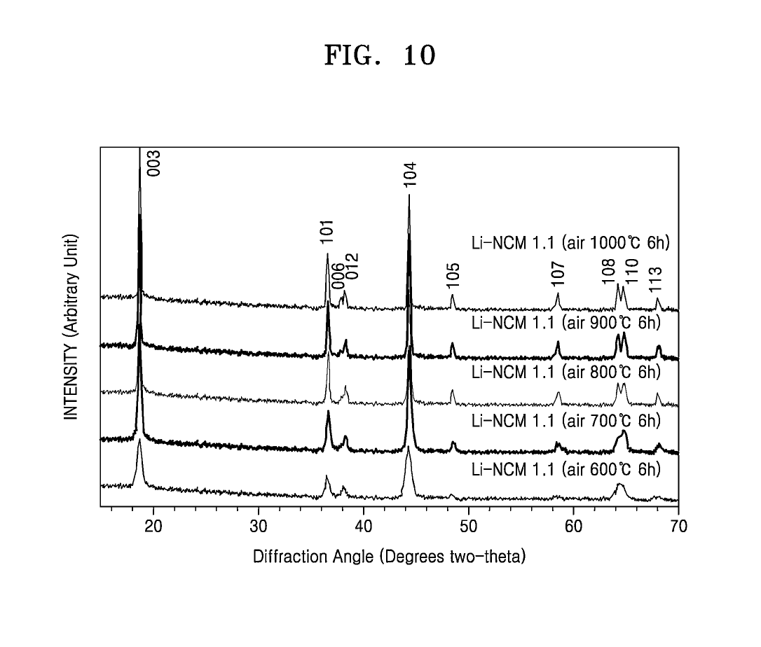

X-ray diffraction patterns of the lithium transition metal oxide prepared in Examples 1, 3, and 5 and Comparative Examples 1 and 2 were measured using CuKα radiation, and the results are shown in FIG. 10.

Diameters of the crystal grains were calculated using locations and full-width half-maximums of peaks corresponding to [003], [104], and [015] reflections and Equation 1, and the calculated diameters are shown in Table 1.

$${D}_{kkl} = \frac{K λ}{β cos θ} \qquad Equation 1$$

D_{ηKλ}: a diameter of grains perpendicular to an (ηKλ) surface (Å)
λ: a wavelength of X-ray (Å)
β: a width of a diffraction ray (rad)
θ: a diffraction angle)(°)
K: a constant (0.9, when a full-width half-maximum β_{1/2} is β)

TABLE 1

| | | [003] | | [104] | | [015] | |
|---|---|---|---|---|---|---|---|
| | | (2θ: 17~20°) | | (2θ: 42.5~46°) | | (2θ: 47~50°) | |
| | Conditions | | Diameter | | Diameter | | Diameter |
| | for each | FWHM | of crystal | FWHM | of crystal | FWHM | of crystal |
| Sample | sample | (β½) | grains (nm) | (β½) | grains (nm) | (β½) | grains (nm) |
| Example 1 | Air, 600° C., 6 h | 0.47973 | 16.78 | 0.16894 | 13.86 | 0.56834 | 15.33 |
| Example 3 | Air, 700° C., 6 h | 0.31487 | 25.57 | 0.4008 | 21.41 | 0.38136 | 22.86 |
| Example 5 | Air, 800° C., 6 h | 0.21949 | 36.68 | 0.28329 | 30.29 | 0.24975 | 34.90 |
| Comparative | Air, 900° C., 6 h | 0.18922 | 42.50 | 0.23775 | 36.09 | 0.23426 | 37.21 |
| Example 1 | | | | | | | |
| Comparative | Air, 1000° C., 6 h | 0.17829 | 45.16 | 0.23885 | 35.92 | 0.25804 | 33.77 |
| Example 2 | | | | | | | |

* FWHM refers to Full Width at Half-Maximum

As shown in Table 1, the diameters of the crystal grains decrease as a heat-treating temperature decreases.

### Evaluation Example 3

### Specific Surface Area Evaluation

Specific surface areas of the lithium transition metal oxide prepared in Examples 1, 3, and 5 and Comparative Examples 1 and 2 were measured using a BET method with a measuring instrument (AS1-A4), and the results are shown Table 2.

TABLE 2

| Sample | Specific surface area (m²/g) |
|---|---|
| Example 1 | 4.67 |
| Example 3 | 3.22 |
| Example 5 | 1.97 |
| Comparative | 1.24 |
| Example 1 | |
| Comparative | 0.51 |
| Example 2 | |

As shown in Table 2, the specific surface areas of the lithium transition metal oxides increase as a heat-treating temperature decreases.

### Evaluation Example 4

### Differential Capacity Analysis

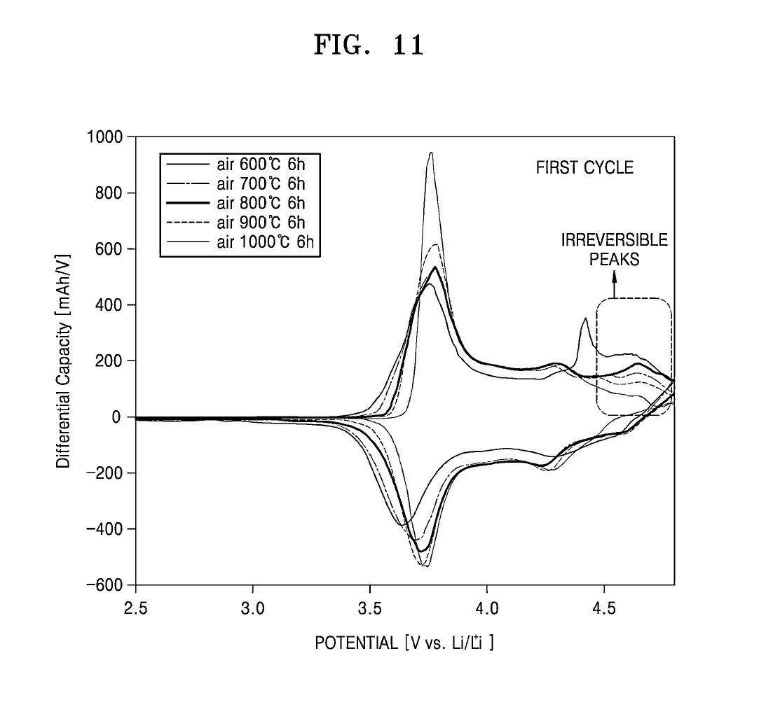

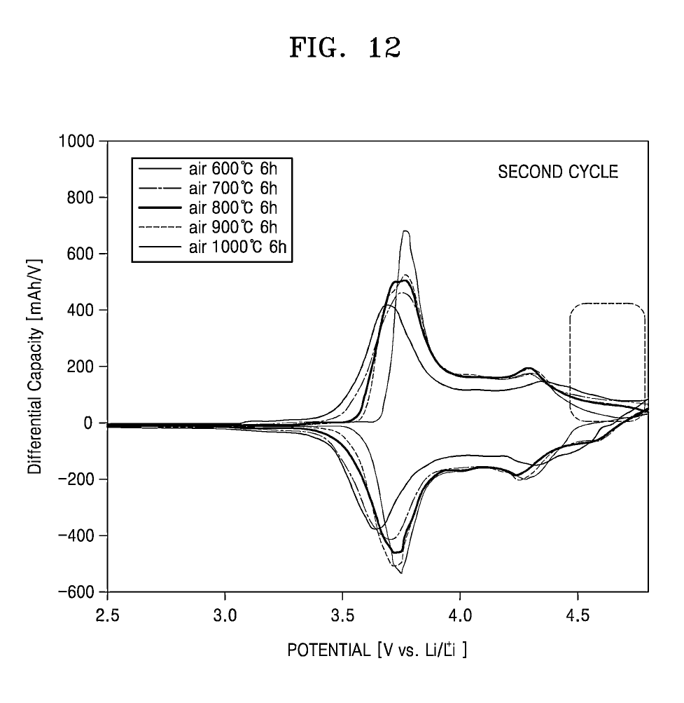

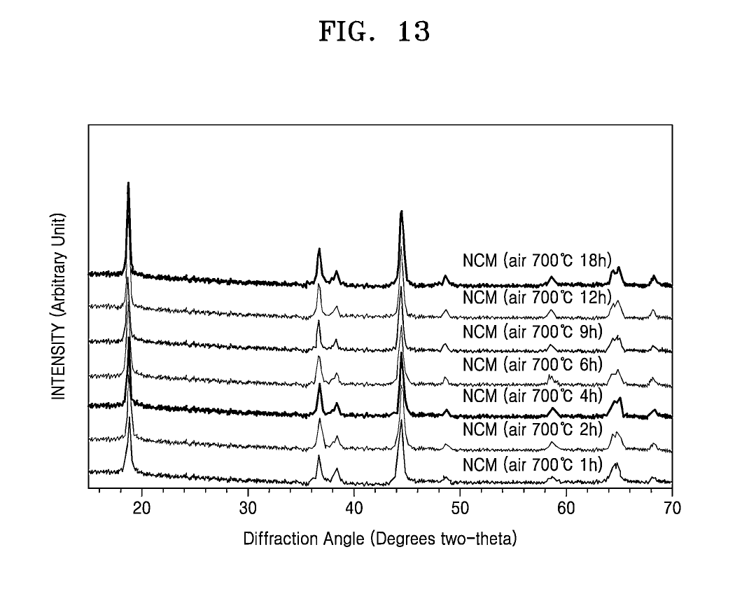

Charging/discharging cycles were performed on the coin half cells prepared in Examples 1, 3, and 5 and Comparative Examples 1 and 2 under the same conditions shown in Table 3 within a range of potentials 2.5 V to about 4.8 V versus lithium at a temperature of 25° C. A dQ/dV graph for the first cycle is shown in FIG. 11 and a dQ/dV graph for the second cycle is shown in FIG. 12. Here, Q represents a capacity, V represents a voltage versus lithium, and dQ/dV represents a differential capacity.

TABLE 3

| | | |
|---|---|---|
| Cycle | Charge | Discharge |

| number | [CC/CV] | End V | [CC] | End V |
|---|---|---|---|---|
| 1 | 0.05 C/0.01 C | 4.8 V | 0.05 C | 2.5 V |
| 2 | 0.05 C/0.01 C | 4.8 V | 0.05 C | 2.5 V |

* CC means constant current, CV means constant voltage

As shown in FIGS. 11 and 12, in the case of coin half cells prepared in Examples 1, 3, and 5, significant irreversible peaks were observed within the potential range of about 4.5V to about 4.8 V versus lithium during the first cycle but disappeared during the second cycle. Also, it was unexpectedly found that intensities of the primary reversible peaks within the potential range of about 3.6 V to about 3.9 V versus lithium decreases as the heat-treating temperatures are relatively low.

The intensities of the primary reversible peaks within the potential range of about 3.6 V to about 3.9 V and the intensities of the irreversible peaks within the potential range of about 4.5 V to about 4.8 V during the first cycle and ratios thereof are shown in Table 4.

TABLE 4

| | | dQ/dV (1) of a primary reversible | dQ/dV (2) of a primary reversible | Ratio of |
|---|---|---|---|---|
| | | peak in a potential range of | peak in a potential range of | dQ/dV (2) |
| | Conditions for | 3.6 V to 3.9 V (3.76 V) | 4.5 V to 4.8 V (4.65 V) | for dQ/dV |
| Sample | each sample | during first cycle | during first cycle | (1) |
| Example 1 | Air, 600° C., 6 h | 477.49 | 222.03 | 0.46 |
| Example 3 | Air, 700° C., 6 h | 533.78 | 190.42 | 0.36 |
| Example 5 | Air, 800° C., 6 h | 541.97 | 156.41 | 0.29 |
| Comparative | Air, 900° C., 6 h | 618.26 | 123.97 | 0.20 |
| Example 1 | | | | |
| Comparative | Air, 1000° C., 6 h | 942.83 | 69.85 | 0.07 |
| Example 2 | | | | |

### Evaluation Example 5

### Electrochemical Characteristics Evaluation

In order to confirm electrochemical characteristics of the lithium transition metal oxides prepared in Examples 1 to 5 and Comparative Examples 1 and 2, a high rate charging/discharging performance, initial efficiencies, and life characteristics were measured as follows. Here, the basis of 1 C was 180 mAh.

The coin half cells prepared in Examples 1 to 5 and Comparative Examples 1 and 2 were charged at room temperature with a constant current of 0.05 C until the voltage reached 4.4 V. Then, the cells were discharged with a constant current of 0.05 C until the cut-off voltage reached 2.5 V. Here, a charge capacity and a discharge capacity (a discharge capacity during the first cycle) were measured, and an initial efficiency (a ratio of a discharge capacity during the first cycle to a charge capacity during the first cycle) was measured therefrom.

Next, the coin half cells were charged with a constant current of 0.5 C in the same manner described above, and then the cells were discharged with a constant current of 0.5 C until the voltage reached 2.5 V. The cycle of charging and discharging were repeated 102 times, and a capacity retention ratio (CRR) of the cells during the 120^{th} cycle was measured to evaluate life characteristics of each of the coin half cells. Here, the capacity retention ratio is defined by Equation 1:

A capacity retention ratio [%]=[A discharge capacity during the 102th cycle/a discharge capacity during the 3^{rd} cycle]×100 Equation 1

The high rate charging/discharging performance evaluation was calculated by obtaining a percentage of a discharge capacity during the life-characteristics evaluation cycle (the 3rd cycle) at a 0.5 C-rate based on a discharge capacity during the first cycle of the 0.5 C-rate discharging.

The measured results of the high rate charging/discharging performance, initial efficiencies, and life characteristics were shown in Table 5.

TABLE 5

| | | Specific | Specific | | | 100^{th} |
|---|---|---|---|---|---|---|
| | | Capacity | Capacity | 0.5 C/0.05 C | Initial | Cycle |
| | | (mAh/g: | (mAh/g: | ratio | Efficiency | Life |
| Sample | Condition | 0.05 C) | 0.5 C) | (%) | (%) | (%) |
| Example 1 | Air 600° C. 6 h | 184.60 | 174.13 | 94.32 | 96.55 | 91.63 |
| Example 2 | Air 650° C. 6 h | 195.04 | 185.42 | 95.07 | 96.53 | 93.21 |
| Example 3 | Air 700° C. 6 h | 205.72 | 195.31 | 94.94 | 97.45 | 94.03 |
| Example 4 | Air 750° C. 6 h | 201.25 | 184.49 | 91.67 | 96.42 | 96.07 |
| Example 5 | Air 800° C. 6 h | 196.64 | 178.77 | 90.91 | 95.49 | 96.50 |
| Comparative | Air 900° C. 6 h | 196.37 | 180.39 | 91.86 | 94.09 | 94.71 |
| Example 1 | | | | | | |
| Comparative | Air 1000° C. 6 h | 176.54 | 153.27 | 86.82 | 85.84 | 85.89 |
| Example 2 | | | | | | |

As shown in Table 5, when the positive electrode active material was heat-treated at a temperature of lower than 800° C., the high rate charging/discharging performance and initial efficiencies of the cells were excellent. The life characteristics of the cells had 90% or more capacity retention ratio when a positive electrode active material heat-treated at a temperature of 800° C. or less. 's Thus, generally the life characteristics of the cells were suitable.

### Evaluation Example 6

### Low Rate Charging/Discharging Characteristics Evaluation

Low rate charging/discharging characteristics of the lithium transition metal oxides prepared in Example 3 and Comparative Example 1 were confirmed in the following manner.

The charging/discharging test was performed by charging the coin half cells prepared in Example 3 and Comparative Example 1 with a current capacity corresponding to 1/20 C, 1/50 C, 1/100 C, or 1/200 C within the potential range of about 2.5 V to about 4.4 V at room temperature to evaluate charging/discharging characteristics of the cells. Here, 1 C was 180 mA/g. Here, a discharge capacity is a gravimetric capacity, and an initial efficiency (I.E.) is defined by a ratio of a discharge capacity during the first cycle/a charge capacity during the first cycle.

TABLE 6

| | | |
|---|---|---|
| | Gravimetric | Initial |
| | Capacity | Efficiency |
| Sample | (mAh/g) | (%) |

| | | | |
|---|---|---|---|
| Example 3 | 1/20 C | 203.67 | 97.64 |
| (Air, 700° C., 6 h) | 1/50 C | 205.65 | 98.13 |
| | 1/100 C | 206.87 | 98.31 |
| | 1/200 C | 208.03 | 98.01 |
| Comparative | 1/20 C | 196.37 | 94.09 |
| Example 1 | 1/50 C | 199.94 | 95.73 |
| (Air, 900° C., 6 h) | 1/100 C | 203.83 | 96.56 |
| | 1/200 C | 202.95 | 97.09 |

As shown in Table 6, when a discharge rate of the positive electrode active material prepared in Comparative Example 1 is reduced to 1/200 C, an initial efficiency at a similar level of the positive electrode active material prepared in Example 1 may be obtained, but it may be known that the initial efficiency of the positive electrode active material prepared in Comparative Example 1 rapidly decreases compared to that of the positive electrode active material prepared in Example 1 at a discharge rate of 1/100 C or greater. Example 3 shows initial efficiency of about 97% or more at a discharge rate of 1/100 C or greater and had uniformly excellent low rate characteristics compared to those of the positive electrode active material prepared in Comparative Example 1. In this regard, it may be said that the difference in the initial efficiencies of the positive electrode active materials prepared in Example 3 and Comparative Example 1 is caused by the difference in kinetic perspective.

### Evaluation Example 7

### Evaluation of Diameter and Electrochemical Characteristics of Crystal Grains According to Heat-Treating Time

Positive electrode active materials were prepared in the same manner used in Example 3, except changing the heat-treating time to 1 hour (h), 2 h, 4 h, 6 h, 9 h, 12 h, and 18 h to observe the change in a crystalline structure and change in electrochemical characteristics according to the heat-treating time.

First, X-ray diffraction patterns were measured by using a CuKα radiation to observe change in a diameter of crystal grains of each of the positive electrode active materials, and the results are shown in FIG. 13. Also, diameters of the crystal grains were calculated using locations and full-width half-maximums (FWHMs) of peaks corresponding to [003], [104], and [015] reflections in FIG. 13 and Equation 1, and the calculated diameters are shown in Table 7.

TABLE 7

| | [003] | | [104] | | [015] | |
|---|---|---|---|---|---|---|
| | (2θ: 17 to 20°) | | (2θ: 42.5 to 46°) | | (2θ: 47 to 50°) | |
| Conditions | | Diameter | | Diameter | | Diameter |
| for each | FWHM | of crystal | FWHM | of crystal | FWHM | of crystal |
| sample | (β_{1/2}) | grains (nm) | (β_{1/2}) | grains (nm) | (β_{1/2}) | grains (nm) |
| Air, 700° C., 2 h | 0.32358 | 24.89 nm | 0.42835 | 20.04 nm | 0.40991 | 21.27 nm |
| Air, 700° C., 4 h | 0.31125 | 25.87 nm | 0.40642 | 21.12 nm | 0.42554 | 20.49 nm |
| Air, 700° C., 6 h | 0.31216 | 25.79 nm | 0.4045 | 21.22 nm | 0.38136 | 22.86 nm |
| Air, 700° C., 9 h | 0.30018 | 26.82 nm | 0.39962 | 21.47 nm | 0.40177 | 21.69 nm |
| Air, 700° C., 12 h | 0.28551 | 28.20 nm | 0.37127 | 23.11 nm | 0.34976 | 24.92 nm |
| Air, 700° C., 18 h | 0.28800 | 27.96 nm | 0.36553 | 23.48 nm | 0.38622 | 22.57 nm |

Also, in order to evaluate electrochemical characteristics of each of the positive electrode active materials, the discharge capacities, initial efficiencies, rate characteristics, and life characteristics of the positive electrode active materials were measured in the same manner used in Evaluation Example 5, and the results are shown in Table 8.

TABLE 8

| | Specific | Initial | 0.5 C/0.05 C | 100 Cycle |
|---|---|---|---|---|
| Conditions for | Capacity | Efficiency | ratio | Life |
| each sample | (mAh/g) | (%) | (%) | (%) |
| Air, 700° C., 1 h | 194.62 | 94.99 | 93.19 | 91.57 |
| Air, 700° C., 2 h | 196.31 | 96.92 | 95.51 | 93.59 |
| Air, 700° C., 4 h | 201.56 | 96.71 | 92.86 | 95.83 |
| Air, 700° C., 6 h | 205.72 | 97.45 | 94.94 | 94.03 |
| Air, 700° C., 9 h | 202.53 | 97.21 | 94.21 | 95.74 |
| Air, 700° C., 12 h | 202.43 | 96.04 | 91.41 | 96.19 |
| Air, 700° C., 18 h | 202.78 | 96.14 | 89.49 | 97.85 |

As shown in Table 7, the diameters of crystal grains generally increase as the heat-treating time increases

As shown in Table 8, the positive electrode active materials have improved electrochemical characteristics, and the life characteristics and capacities of the positive electrode active materials increase as the heat-treating time increases. Unexpectedly, the initial efficiency and the high rate charging/discharging performance may have the best characteristics in the samples synthesized with 6 hours of heat-treatment. It is observed that slightly increasing the heat-treating temperature may result similar to increasing heat-treating time.

As described above, a lithium battery including a positive electrode active material that is manufactured according to the one or more of the above embodiments may have an improved initial efficiency and an increased discharge capacity.

It should be understood that the exemplary embodiments described herein should be considered in a descriptive sense only and not for purposes of limitation. Descriptions of features, advantages, or aspects within each embodiment should be considered as available for other similar features, advantages, or aspects in other embodiments.

What is claimed is:

1. A positive electrode active material comprising: a lithium transition metal oxide, wherein when a lithium battery comprising a positive electrode comprising the lithium transition metal oxide is analyzed by differential capacity analysis, an irreversible peak is present in a graph of differential capacity versus voltage in a range of about 4.5 volts versus lithium to about 4.8 volts versus lithium during a first charge/discharge cycle.

2. The positive electrode active material of claim 1, wherein a ratio of a differential capacity of the irreversible peak on oxidation to a differential capacity of a largest reversible peak appearing in a range of about 3.6 volts versus lithium to about 3.9 volts versus lithium on oxidation during the first charge/discharge cycle is 0.3 or greater.

3. The positive electrode active material of claim 1, wherein the irreversible peak is not present after a second charge/discharge cycle.

4. The positive electrode active material of claim 1, wherein the lithium transition metal oxide is represented by Formula 1:
LiₐNi_{b}Co_{c}Mn_{d}M_{f}O₂₋ₓFₓ Formula 1
wherein M is at least one metal selected from Ti, V, Al, Mg, Cr, Fe, Zr, Re, Al, B, Ge, Ru, Sn, Nb, Mo, and Pt;
0.8≦a≦1.2, 0<b<1, 0<c<1, 0<d<1, 0≦f<1, and 0.8≦b+c+d+f≦1.2; and
0≦x<0.1.

5. The positive electrode active material of claim 4, wherein the lithium transition metal oxide is represented by Formula 2:
LiₐNi_{b}Co_{c}Mn_{d}O₂ Formula 2
wherein 0.8≦a≦1.2, 0<b<1, 0<c<1, 0<d<1, and 0.8≦b+c+d≦1.2.

6. The positive electrode active material of claim 1, wherein the positive electrode active material has a full-width at half-maximum of a [003] peak of about 0.2° or greater, wherein the full-width at half-maximum of the [003] peak appears in a range of a diffraction angle between 17° and 20° two-theta when analyzed by X-ray diffraction analysis using a CuK α-ray.

7. The positive electrode active material of claim 1, wherein the positive electrode active material has a BET specific surface area of about 2 square meters per gram or greater.

8. The positive electrode active material of claim 1, wherein the positive electrode active material comprises secondary particles which comprise an agglomeration of primary particles, and wherein the primary particles have a rod shape.

9. The positive electrode active material of claim 8, wherein the primary particles have a rod shape with a length to thickness ratio of at least about 1.5.

10. The positive electrode active material of claim 8, wherein a diameter of a crystal grain in a polycrystalline structure of the primary particles is less than about 40 nanometers.

11. The positive electrode active material of claim 8, wherein an average particle diameter of the secondary particles is in a range of about 1 μm to about 100 μm.

12. The positive electrode active material of claim 1, wherein the positive electrode active material further includes an amorphous carbon layer on a surface thereof.

13. The positive electrode active material of claim 12, wherein the amorphous carbon layer comprises an amorphous carbon comprising at least one selected from soft carbon, hard carbon, a mesophase pitch carbide, and a sintered coke.

14. The positive electrode active material of claim 12, wherein a thickness of the amorphous carbon layer is in a range of about 0.01 micrometers to about 10 micrometers.

15. A lithium battery comprising:
a positive electrode comprising the positive electrode active material of claim 1;
a negative electrode that is disposed facing the positive electrode; and
an electrolyte that is disposed between the positive electrode and the negative electrode.

16. A method of manufacturing a positive electrode active material, the method comprising:
providing a mixture comprising a transition metal precursor and a lithium precursor; and
heat-treating the mixture at a temperature of 800° C. or less to prepare a lithium transition metal oxide to prepare the positive electrode active material.

17. The method of claim 16, wherein the mixture comprising the transition metal precursor and the lithium precursor is a solution.

18. The method of claim 16, wherein the transition metal precursor comprises a compound of the formula Ni_{b}Co_{c}Mn_{d}M_{f}(OH)_{y}, wherein 0.8≦b+c+d+f≦1.2; 0<b<1, 0<c<1, 0<d<1, 0≦f<1; and 1.8≦y≦2.2.

19. The method of claim 16, wherein the lithium precursor comprises at least one selected from LiOH, Li₂Co₃, LiNH₂, LiCl, and LiBr.

20. The method of claim 16, wherein the mixture further comprises at least one fluoride compound selected from lithium fluoride, magnesium fluoride, strontium fluoride, beryllium fluoride, calcium fluoride, ammonium fluoride, ammonium bifluoride, and ammonium hexafluoroaluminate.

21. The method of claim 16, wherein the heat-treating of the mixture is performed at a temperature in a range of about 650° C. to about 750° C.
